(19) United States
(12) Patent Application Publication
(10) Pub. No.: US 2026/0043703 A1
(43) Pub. Date: Feb. 12, 2026

(54) PRESSURE SOURCE LOCALIZATION USING A MULTI-SENSOR WEARABLE DEVICE FOR BLAST AND SOUND WAVES

(71) Applicant: Advanced Materials and Devices, Reno, NV (US)

(72) Inventors: Kyle Willens, Carson City, NV (US); Darion Homayoon, Reno, NV (US); Blake Muzinich, Reno, NV (US); Barkan Kavlicoglu, Reno, NV (US); Faramarz Gordaninejad, Reno, NV (US)

(73) Assignee: Advanced Materials and Devices, Reno, NV (US)

(21) Appl. No.: 18/799,877

(22) Filed: Aug. 9, 2024

(51) Int. Cl. G01L 19/00; G01L 15/00; G01P 13/00

(52) U.S. Cl. CPC G01L 19/0092; G01L 15/00; G01P 13/0006

(57) ABSTRACT

The uniqueness of the present invention is the development of methods for determining the source localization of transient pressure events, such as blast and sound waves originating from explosions, or other pressure sources, with the preferred embodiment using the illustrated example of a multi-sensor wearable device (MSWD), but any multi-sensor wearable device may be used. This device combines pressure transducers, inertial sensors, and navigational sensors to identify the direction of a pressure source. The invention employs diverse techniques—pressure time-based, pressure amplitude-based, inertial amplitude-based, and/or machine learning—to enhance accuracy. The calculated source location can be used to determine a sensors orientation to the source to estimate a reflected and/or incident pressure. The directional analysis is vital for assessing the impact of pressure waves on surfaces, improving injury assessment, and enhancing safety evaluations as the direction of the blast wave may have different effects on injury outcomes.

### PRIORITY CLAIM

Priority is claimed on the following application: Country: Unites States of America, Application No. 63/519,244, Filed: Aug. 12, 2023, the content of which is/are incorporated herein by reference in its entirety.

### BACKGROUND

Transient pressure events, such as blasts and sound waves generated by explosions and other pressure events, have garnered significant attention due to their potential implications for safety, security, and environmental monitoring. The accurate localization of these pressure sources is critical for understanding their characteristics, mitigating potential risks, and optimizing response strategies. Traditional methods for pressure source localization often involve stationary sensor networks, which may be limited in capturing dynamic and complex events.

In recent years, wearable sensor technologies have emerged as promising solutions for real-time data collection in dynamic environments. Wearable sensors provide the advantage of mobility and adaptability, enabling the monitoring of pressure events across various scenarios and locations. The integration of pressure transducers, inertial sensors, and navigational sensors within a compact wearable device, known as a Multi-Sensor Wearable Device (MSWD), offers a new approach to address the challenges of accurate pressure source localization.

The field of wearable blast sensors has, until recently, faced significant limitations in its ability to fully capture the dynamics of blast events. Existing devices measure and record blast pressure exposure but are confined to unidirectional measurements, lacking the capacity to discern the directionality of a blast. This unidirectional constraint, along with other deficiencies such as inadequate sampling rates, limited resolution, and poor ingress protection, has restricted the utility and reliability of these tools. For example, some devices operate at insufficient sampling frequencies, limiting their ability to capture high-fidelity blast pressure data necessary for precise injury determinations based on peak pressure, impulse, or other methods, including pressure source localization.

The need for a more reliable and comprehensive solution for determining pressure source localization in this field is evident. Such a solution would not only fill a substantial gap in the current state of the art but also holds significant potential in improving the safety and well-being of individuals exposed to blasts. Calculating the direction of the pressure event enables more accurate adjustments and reporting of incident and reflected pressures, considering the angle of incidence relative to the sensor's orientation. This directional analysis is particularly important as the directionality of a blast wave can have varying effects on injury outcomes, making accurate directional analysis crucial for both immediate response and long-term safety evaluations.

Reflected and incident pressures play a crucial role in understanding the full impact of transient pressure events, particularly in the context of explosions and blast waves. Incident pressure refers to the initial pressure wave that directly reaches a surface or sensor from the blast source. This wave provides essential data on the intensity and speed of the blast as it travels through the medium. When this wave encounters a surface, such as a sensor or any other object, it is partially absorbed and partially reflected, creating a secondary wave known as reflected pressure. The magnitude of reflected pressure can be significantly higher than the incident pressure, influenced by factors such as the angle of incidence, the properties of the reflecting surface, and environmental conditions.

The orientation of the sensor relative to the incoming pressure wave is critical in accurately measuring these pressures. When a sensor's face is directly pointed at the pressure source, typically parallel or at a 0-degree angle to the pressure wavefront, it primarily measures the reflected pressure. This orientation allows the sensor to capture the pressure wave as it is reflected from the surface, often resulting in a higher pressure reading than the incident pressure alone. Conversely, when a sensor's face is aligned perpendicular to the incoming wavefront, typically at a 90-degree angle, it primarily measures the incident pressure. In this orientation, the sensor detects the pressure wave as it passes over the sensor without significant reflection, providing a clear measurement of the wave's initial impact.

The presented invention allows the calculation of the direction of the pressure event, enabling the adjustment of the pressure readings based on the sensor's orientation, ensuring that both incident and reflected pressures are accurately reported. The sensor orientation is crucial for understanding the dynamics of pressure events. Accurately capturing both types of pressure requires careful consideration of sensor placement and orientation, as the differences in pressure readings can have significant implications for damage assessment and injury prediction.

Understanding the direction of a blast wave is also crucial for accurately assessing injuries and their severity. The angle at which a pressure wave strikes the body can significantly influence the type and extent of injuries sustained. For instance, a blast wave approaching from the front (0 degrees) might lead to different injury patterns compared to a wave hitting from the side (90 degrees). By analyzing the direction of the blast, the presented invention will provide more precise data on the likely areas of impact on the wearer's body, leading to better predictions of injury severity and type. This information is vital for both immediate medical response and the design of protective gear, as different angles of blast exposure may require different types of protection. Furthermore, understanding the directionality of pressure waves helps in optimizing safety protocols and improving the overall well-being of individuals in environments at risk of explosive events.

Understanding the sensor orientation is essential for accurately determining both incident and reflected pressures. The accurate measurement of these pressures is vital for making precise predictions about potential damage or injury, as reflected pressure, often more intense, can cause greater structural damage or more severe injuries than the incident pressure alone. This level of detail is critical for improving blast response strategies, designing effective protective equipment, and enhancing the overall safety of environments exposed to such hazards, ensuring that all relevant factors are considered in the analysis and mitigation of pressure events.

This innovation not only enhances the precision of pressure source localization but also enables the incorporation of diverse methodologies to extract detailed information from the pressure event. By combining wearable convenience, multi-sensor integration, and sophisticated methodologies, the presented invention offers a powerful solution for accurately characterizing and localizing transient pressure events in various scenarios. The presented invention capitalizes on advancements in sensor miniaturization (MSWD), allowing the integration of multiple sensors with fixed positions in a single wearable unit.

### BRIEF SUMMARY OF THE INVENTION

The present invention uses a Multi-Sensor Wearable Device (MSWD) that facilitates the determination of source localization for transient pressure events, such as blast and sound waves. Those skilled in the art will appreciate that the MSWD referenced herein is an illustrative example, any device incorporates an array of sensors (in one device or many), which can include pressure transducers, inertial sensors, and navigational sensors, within a wearable form factor could be used. This invention identifies multiple methodologies and approaches to determine the direction of the pressure source in various scenarios using an MSWD. The utilization of time-based analysis, amplitude-based methodologies, inertial amplitude-based computations, and machine learning techniques within the MSWD presents a versatile toolkit for determining pressure source direction. These methodologies leverage the temporal behavior of pressure waveforms, the varying amplitudes across sensors, and the movement vectors inferred from peak acceleration data. By combining these approaches, an MSWD and resultant localization methods provide a comprehensive solution for accurate pressure source localization.

The methodologies described can be used for the analysis of transient pressure wave events, such as but not limited to blasts and sound waves emanating from explosions or other pressure sources. The source localization determination establishes blast wave direction with respect to the center of the pressure sensor array within the wearable MSWD. Central to this invention, the preferred embodiment of an MSWD is a wearable Multi-Directional Blast Sensor (MDBS), which integrates multiple pressure sensors, inertial sensors, and navigational sensors into a singular, fixed-position device. The positions of all sensors in the MDBS are fixed, such that they cannot move with respect to each other. The MDBS ensures that sensor positions remain constant in relation to one another, thus optimizing accuracy during source localization determination, and all sensors are processed and recorded with a central controller, ensuring time synchronization.

Incorporating a pressure time-based methodology, the presented invention leverages temporal indices of pressure rise and/or peaks across the sensor array. Techniques such as multilateration, triangulation, beamforming, and cross-correlation are employed, where the time differentials between sensors and their respective positions enable the deduction of the blast source direction. A pressure amplitude-based methodology assigns weights to sensor locations based on peak pressure amplitudes, and a resulting sensor array is calculated, yielding a calculated source direction that aligns with the positions of the highest amplitude sensors.

The inertial amplitude-based methodology utilizes peak acceleration data from inertial sensors to compute an acceleration vector. By analyzing the peak accelerations along the XYZ axes, the method determines both the direction and magnitude of the MSWD's movement because of the pressure acting on the MSWD, thus determining the pressure source direction from the acceleration vector.

The presented invention can incorporate machine learning techniques, involving the collection of pressure data through the wearable MSWD. Relevant features are extracted from the signals and used to train a machine learning model with labeled source locations. Once trained, the model can predict blast or sound source locations, offering a high degree of accuracy for source localization.

An additional feature of the invention involves analyzing the calculated position of the source, yielding azimuth, α, and elevation, ε angles. These angles depict the source's orientation relative to the MSWD. These angles can be correlated with descriptors in specific ranges, facilitating intuitive interpretation, such as front-left with respect to the MSWD. The presented invention utilizes inertial and navigational sensors contained in an MSWD to determine its orientation during the event and can adjust the blast direction determination to account for the MSWD's orientation. This adjustment ensures that the reported direction is in reference to a level surface. For enhanced navigational precision, a navigational instrument, such as a magnetometer, can be utilized to determine the array's heading, thus enabling reporting relative to true north or other geographic directions.

One aspect of the invention is an MSWD that incorporates pressure sensors, inertial sensors, and/or navigational sensors to sense and record data from a pressure source. The data is processed, and the position of the source with respect to the MSWD is calculated. Enabling the MSWD to distinguish and report both incident and reflected pressures based on the calculated direction, providing a more comprehensive understanding of the pressure event.

A key feature of this invention is enabling an MSWD's ability to report both incident and reflected pressures of a pressure event accurately. By calculating the direction of the pressure source, the MSWD can adjust pressure readings based on the angle of incidence relative to each sensor's orientation. Each sensor in the MSWD is mapped and the orientation can be used to adjust or scale the measured pressure to report an incident and reflected pressure. This ability to distinguish and accurately report both incident and reflected pressures is crucial for understanding the full impact of pressure events, which can vary significantly based on the directionality of the blast wave.

In a preferred embodiment, the wearable MSWD can be a wearable Multi-Directional Blast Sensor (MDBS) that incorporates multiple pressure sensors, inertial sensors, and navigational sensors in one device with all positions fixed.

According to another aspect of the invention, the MSWD consists of a recording instrument that samples data from the sensors, processes, and records the data to non-volatile memory.

According to another aspect of the invention, the data sensed by the MSWD is processed in real-time for source position calculation.

According to another aspect of the invention, the data sensed by the MSWD is recorded to non-volatile memory with a recording instrument and post-processed with the recording instrument.

According to another aspect of the invention, the data sensed by the MSWD is recorded to non-volatile memory and post-processed with an external device, such as a mobile device or computer, where the data is transferred wirelessly or wired.

According to another aspect of the invention, the data sensed by the MSWD is processed, and two-dimensional (2D) or three-dimensional (3D) analytical approaches can be used to determine the source pressure location.

According to another aspect of the invention, the pressure data sensed by the MSWD is processed in real-time or post-processed using a time-based method, leveraging temporal indices of pressure rise and/or peaks across the sensor array to determine the source pressure location.

According to another aspect of the invention, the pressure data sensed by the MSWD is processed in real-time or post-processed using an amplitude-based methodology that assigns weights to sensor locations based on peak pressure amplitudes to determine the source pressure location.

According to another aspect of the invention, the inertial data sensed by the MSWD is processed in real-time or post-processed using an inertial amplitude-based methodology that utilizes peak acceleration data to compute a movement vector to determine the source pressure location.

According to another aspect of the invention, machine learning is implemented using data from a wearable MSWD and training a machine learning model with labeled source locations to determine the source pressure location.

According to another aspect of the invention, the MSWD can process and report both incident and reflected pressures based on the calculated direction of the pressure event, enabling a comprehensive understanding of the pressure event's impact.

According to another aspect of the invention, a combination of pressure-time-based, pressure-amplitude-based, inertial-amplitude-based, and/or machine learning-based methodologies can be implemented to determine the source pressure location.

According to another aspect of the invention, an inertial sensor can be used to determine the wearable sensor array's orientation during the event to augment the calculated source pressure location and give an output with respect to a level plane.

According to another aspect of the invention, a navigational sensor can be used to determine the wearable sensor array's heading with respect to true north or other geographical location.

According to another aspect of the invention, other sensors besides pressure, inertial, or navigation sensors can be used in the MSWD to determine other aspects of the event.

According to another aspect of the invention, other sensors besides pressure, inertial, or navigation sensors can be used in the MSWD, and the same methodologies can be implemented to determine the source location of a signal of interest.

### BRIEF DESCRIPTION OF DRAWING FIGURES

FIG. 1 is an isometric view of a wearable multi-directional blast sensor with multiple integrated sensors indicating the defined positive xyz axes and sensor positions with x and y dimensions L, and Z, respectively.

FIG. 2 is an isometric view of a wearable multi-directional blast sensor defining the azimuth, α, positive direction measured clockwise about the y-axis in the x-y plane, and the elevation, ε, positive direction measured counterclockwise about the x-axis in the y-z plane.

FIG. 3 is an example with 25 ms pressure history of five sensors recorded on a wearable multi-directional blast sensor with each sensor's pressure history offset by 10 psi for visual clarity.

FIG. 4 is an example with 0.5 ms pressure history of five sensors recorded on a wearable multi-directional blast sensor during a controlled blast test at a defined 0° azimuth and 0° elevation blast source with respect to the sensor and the time of arrivals labeled t₁, t₂, t₃, t₄, and t₅ and each sensor's pressure history offset by 10 psi for visual clarity.

FIG. 5 is an example with 0.5 ms pressure history of five sensors recorded on a wearable multi-directional blast sensor during a controlled blast test at a defined 30° azimuth and 0° elevation blast source with respect to the sensor and the time of arrivals labeled t₁, t₂, t₃, t₄, and t₅ and each sensor's pressure history offset by 10 psi for visual clarity.

FIG. 6 is an example with 0.5 ms pressure history of five sensors recorded on a wearable multi-directional blast sensor during a controlled blast test at a defined 45° azimuth and 0° elevation blast source with respect to the sensor and the time of arrivals labeled t₁, t₂, t₃, t₄, and t₅ and each sensor's pressure history offset by 10 psi for visual clarity.

FIG. 7 is an example with 0.5 ms pressure history of five sensors recorded on a wearable multi-directional blast sensor during a controlled blast test at a defined 60° azimuth and 0° elevation blast source with respect to the sensor and the time of arrivals labeled t₁, t₂, t₃, t₄, and t₅ and each sensor's pressure history offset by 10 psi for visual clarity.

FIG. 8 is an example with 0.5 ms pressure history of five sensors recorded on a wearable multi-directional blast sensor during a controlled blast test at a defined 90° azimuth and 0° elevation blast source with respect to the sensor and the time of arrivals labeled t₁, t₂, t₃, t₄, and t₅ and each sensor's pressure history offset by 10 psi for visual clarity.

FIG. 9 presents a flowchart of events staring from data collection to processing and analysis demonstrating the intermediate steps that are computed for source localization, angle calculation, blast direction adjustment and scaling factor application.

### DETAILED DESCRIPTION OF THE INVENTION

The present invention utilizes an MSWD to determine the source localization of transient pressure events such as blast and sound waves. The MSWD can integrate at least one pressure transducer, with or without inertial sensors and/or navigational sensors. Additional sensors may be incorporated to determine more information about the event. The present invention is particularly useful when used with an MDBS 1 for determination of blast source localization. Other types of sensors, such as a universal blast sensor², may be utilized. Those skilled in the art will appreciate that any device that incorporates an array of sensors (in one device or many), which can include pressure transducers, inertial sensors, and navigational sensors, within a wearable form factor could be used.

Pressure transducers may be used to sense pressure or sound waves and are commonly of the type of strain gauge, piezoelectric, or microelectromechanical systems (MEMS), other types of pressure transducers may be used with similar results. Inertial sensors may be used to sense the inertia of the MSWD during the event and can consist of translational and rotational accelerometers. Navigational instruments can also be used in the MSWD and may utilize a magnetometer which can be useful to determine the MSWD heading with respect to true north or other geographic direction. The MSWD can consist of a controller that samples, processes, and records sensor data to non-volatile memory. The data can be processed in real-time or post-processed to employ methodologies for determining the source location of the pressure. If the controller does not record data to non-volatile memory, real-time processing can be used to determine the source location. Indication of the source location can be achieved by different means such as light indication, graphical indication, sound indication, or tactile indication on the MSWD itself, or on external devices after post-processing.

Data from the MSWD can be transferred to external devices wirelessly or wired. The MSWD can be a portable electronic device that is battery powered or wired to a power supply. The sensors in the MSWD can be wired directly to the controller of the MSWD, or to an external device(s) for processing the data. The preferred embodiment of the MSWD is a portable electronic device that is battery powered and all sensors are wired to a controller all housed in one housing, such as a MDBS 1.

Sensor data from the MSWD is processed and methodologies are employed to determine the source localization of the transient pressure event. Single methods or a combination of methods from different sensor data or different analyses of sensor data can be used for source localization calculation to reinforce direction detection accuracy. In all methodologies, two-dimensional (2D), or three-dimensional (3D) approaches may be employed. The processed data from a wearable MSWD presents a characterization of blast wave direction, offering both quantitative measurements and qualitative insights into blast dynamics. When a 2D approach is employed, sensor locations are defined with x and y coordinates. The elevation, ε, angle is not calculated. When a 3D approach is used, the sensor locations are defined with x, y, and z coordinates, and the azimuth, α, and elevation, ε, angles are calculated.

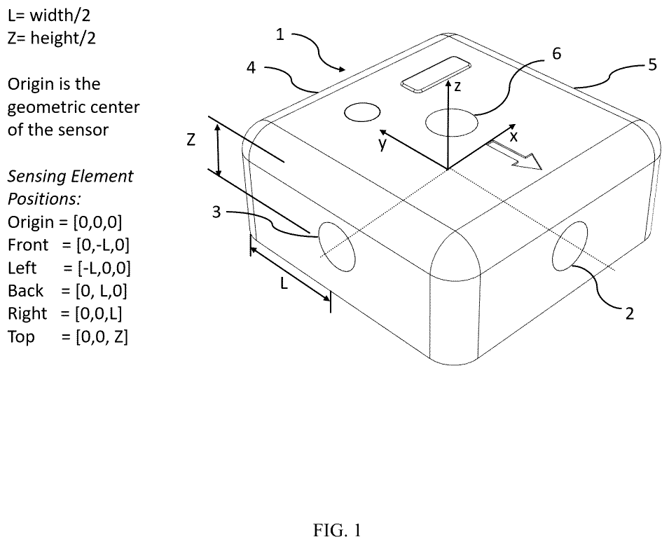

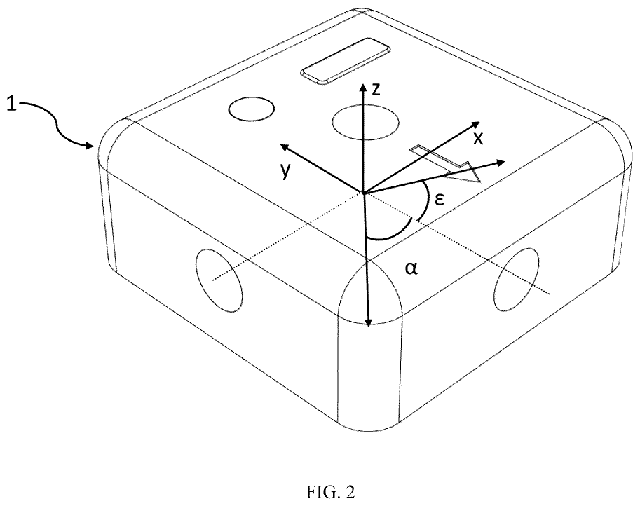

The MDBS 1 using the present invention for source localization determination is shown in FIG. 1. The MDBS has the positive x, y, and z axes defined. An array of sensor positions is listed in FIG. 1. In the instance of the MDBS, the x-y coordinate system of the pressure sensors is symmetrical and equal, but this is not a requirement for the source localization determination. The MDBS has pressure sensors in locations defined as front 2, left 3, back 4, right 5, and top 6. Internal to the MDBS are inertial and navigational sensors not depicted in FIG. 1. The azimuth, α, and elevation, ε, angles with respect to the MDBS 1 are shown in FIG. 2.

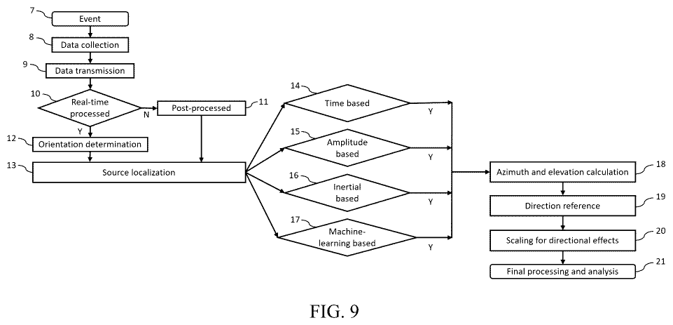

FIG. 9. outlines the data processing and analysis workflow for the MSWD. The process begins with an event 7 followed by data collection 8, where sensors on the MSWD gather pressure, inertial, and navigational data. Pressure transducers detect pressure or sound waves, inertial sensors measure translational and rotational accelerations, and magnetometers determine heading. This sensor data is then transmitted 9 to the MSWD controller, where it is either processed in real-time 10 or recorded for post-processing 11. The MSWD's orientation is determined 12 based on inertial and navigational sensors, with the blast direction being refined accordingly. Source localization 13 follows, utilizing methods like time-based 14 analysis, pressure amplitude 15 based, inertial 16 based, and/or machine learning 17 to determine the source location. Azimuth and elevation angles are calculated 18 to describe the source position relative to the MSWD. The blast direction can be further adjusted to ensure it references 19 a flat and level surface, with heading information used to report the direction relative to geographic directions or other direction. A scaling factor 20 is applied to adjust pressure readings for directional effects, providing accurate estimations of incident and reflected pressures. Finally, adjusted pressure readings can be further processed in real-time or post-processed for analysis 21, with machine learning algorithms or other methods to refine estimation accuracy, resulting in reliable incident and reflected pressure data for detailed analysis and response during and after a blast event.

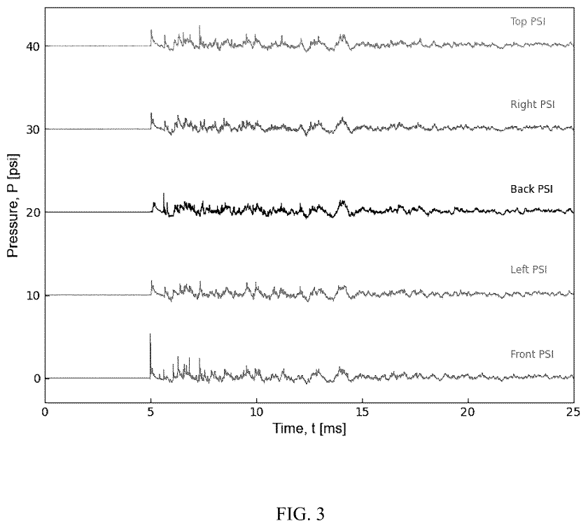

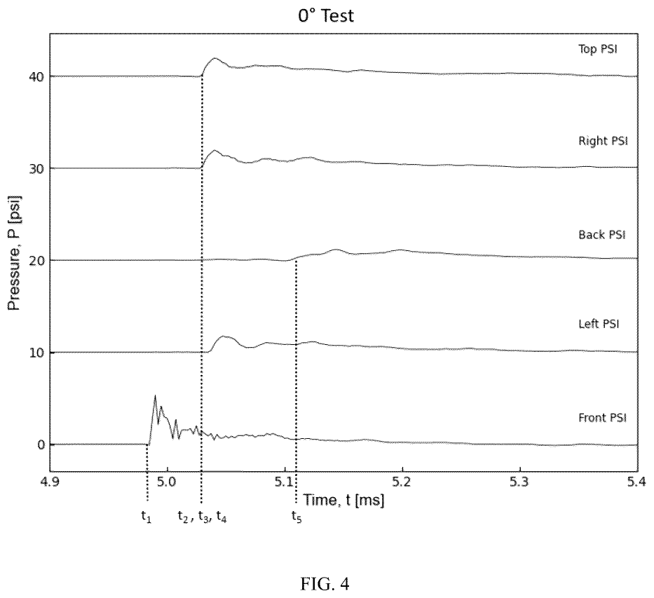

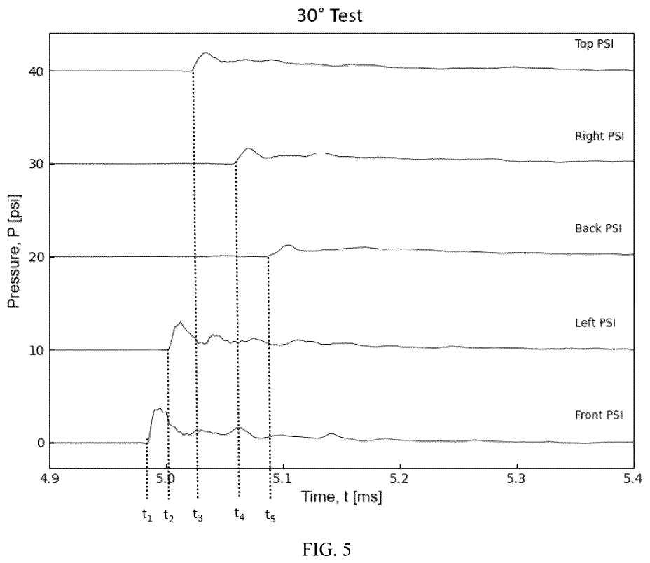

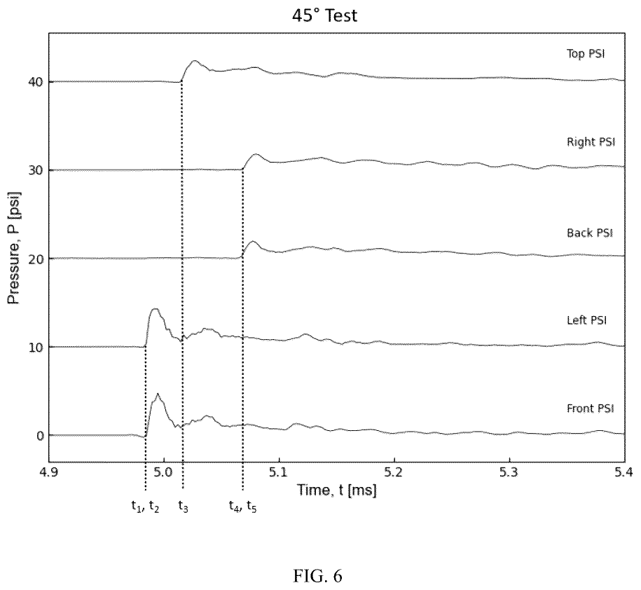

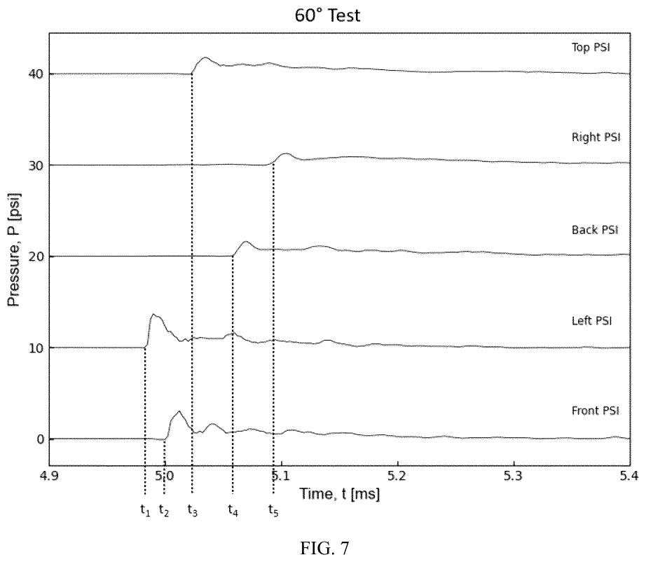

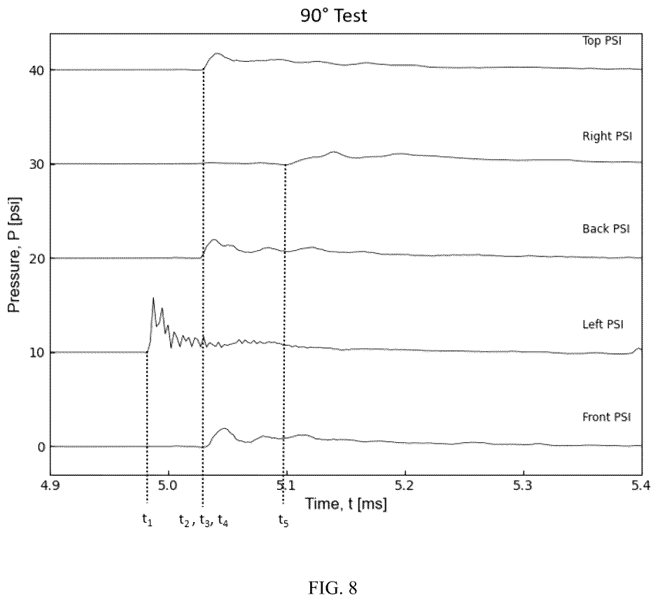

One method for source localization 13 determination is time-based 14, leveraging the temporal indices of pressure rise and/or peaks across the sensor array. The application of methodologies for example includes, but is not limited to, multilateration³, triangulation, beamforming, and cross-correlation. Those skilled in the art will appreciate that any valid method may be used. The direction of the blast source can be deduced from the time differentials between sensors and their respective positions. In the instance of multilateration, the time difference of arrival (TDOA) of each sensor can be used. The sensors'position is defined in a position array, for example, the MDBS 1 in FIG. 1. The TDOAs are calculated as the difference in time from the first sensor receiving the pressure to the time each respective sensor in the array receives the pressure. FIG. 3 is an example blast event 25 ms pressure history measured with an MDBS 1 with a controlled and defined 0° azimuth and 0° elevation and each sensor's pressure history offset by 10 psi for visual clarity. FIG. 4 is an example blast event with a 0.5 ms pressure history measured with an MDBS 1 with a controlled and defined 0° azimuth and 0° elevation source illustrating the temporal differences in pressure sensed with an MSWD and each sensor's pressure history offset by 10 psi for visual clarity. The front 2, left 3, back 4, right 5, and top 6 sensors sense the blast pressure at times t₀, t₁, t₄, t₃, and t₂, respectively. In the instance of a 0° azimuth and elevation source, the front 2 sensor senses the blast first, the left 3, right 5, and top 6 sensors sense the blast next and nearly at the same time, and the back 4 sensor senses the blast last. FIGS. 5-8 are example blast events measured with an MDBS 1 at a controlled and defined 30°, 45°, 60°, and 90° azimuth, respectively, and 0° elevation source illustrating the change in temporal differences in pressure sensed with an MSWD compared to the 0° azimuth source shown in FIG. 4.

Another method for source localization 13 determination relies on pressure amplitudes 15 sensed by sensors in an MSWD. A weight function can be assigned to sensor locations based on peak pressure amplitudes. As shown in FIGS. 2-6, peak pressure amplitudes are sensed differently at each sensor location. The sensors with the higher amplitudes typically receive the signal first, and their position can weigh higher. A resulting direction can be determined with the analysis of the weighted sensor positions. For example, the weighted sensor positions can be added up to determine a resulting sensor array, and vector calculations can be performed to determine the azimuth and elevation angles of the resulting position.

Another method for source localization 13 determination uses the measurements of an inertial 16 sensor(s) in the instance that the MSWD has inertial sensors. Utilizing 2D or 3D peak acceleration data, either translational or rotational, the computation of a movement vector is performed. This involves analyzing the highest accelerations along xyz coordinate system to determine both the direction and magnitude of movement. The azimuth and elevation angles can be calculated from the acceleration vector.

Another method for source localization 13 determination uses machine learning 17 and involves collecting pressure data using a wearable MSWD, extracting relevant features from the signals, and training a machine learning model with labeled source locations. Once trained, the model can predict blast or sound source locations from new data, enabling accurate source localization for various applications such as explosion monitoring or acoustic event tracking.

The invention incorporates a feature that analyzes the calculated position of the source 18. Using a 3D methodology, the analysis yields two angles an azimuth angle (α) and an elevation angle (ε). These angles describe how the source is positioned in relation to the wearable MSWD. These angles can be linked to descriptors defined in specific ranges. For instance, a source arriving from a 45° azimuth angle can be described as arriving from the front-left with respect to the MDBS 1. During the event, the wearable MDBS utilizes its inertial sensors along with other environmental or navigational sensors to determine its orientation. The orientation information is then used to redefine the determination of the blast direction. It may involve adjusting the determined direction by accounting for the sensor array's orientation. This adjustment can ensure that the reported direction of the source wave is in reference to a flat and level surface. For more precise navigational data, a navigational instrument such as a magnetometer can be used. It aids in determining the heading of the sensor array during the event. This heading information can then be used to report the blast direction relative to true north or other geographic directions.

Furthermore, the invention includes a methodology for enhancing pressure measurement accuracy by applying a scaling factor 20 based on the blast direction. This involves determining the direction of the blast using inertial sensors and pressure data from the wearable multi-sensor array. A scaling factor is then calculated according to the blast direction and the relative orientation of each sensor. This factor is applied to the pressure readings to adjust for directional effects, enabling accurate estimations of both incident and reflected pressures. These adjusted readings provide real-time or post-processed data for more precise pressure measurements. Additionally, machine learning algorithms can be employed to refine the scaling factors and improve the accuracy of these estimations. This advanced processing ensures that the wearable MSWD delivers reliable incident and reflected pressure data, critical for detailed analysis and response during and after a blast event.

What is claimed is:

1. Method(s) for determining the pressure source location using a wearable multi-sensor array, comprising of a combination of pressure-time-based, pressure-amplitude-based, inertial-amplitude-based, and machine learning-based methodologies to determine the source pressure location by:
utilizing a pressure time-based method employing temporal indices of pressure rise and/or peaks across the sensor position array to determine the source pressure location,
utilizing a pressure amplitude-based methodology assigning weights to sensor locations based on peak pressure amplitudes to determine the source pressure location,
processing inertial data sensed by the inertial sensors in real-time or post-processing,
utilizing an inertial amplitude-based methodology employing peak acceleration data to compute an acceleration vector and determine the source pressure location,
implementing machine learning using data from the wearable multi-sensor array,
training a machine learning model with labeled source locations to determine the source pressure location,
processing pressure data sensed by the pressure sensor(s) in real-time or during post-processing.

2. Method(s) for enhancing pressure measurement accuracy using blast direction, by applying a scaling factor to the multiple sensors to report an estimated incident, reflected, or overall pressure, comprising:
determining the direction of the blast using the sensors data from the wearable multi-sensor array,
calculating a scaling factor based on the determined blast direction and the relative orientation of each sensor,
applying the scaling factor to the sensor readings from each sensor to adjust for directional effects based on the geometry and orientation of the sensors relative to the source direction,
processing the data in real-time or during post-processing to provide accurate incident, reflected, or overall pressure estimates, and
utilizing machine learning or other algorithms to refine the scaling factors and improve the accuracy of the incident and reflected pressure estimations based on historical data and real-time feedback.

3. Whereas the wearable multi-sensor array of claim 1 is a Multi-Sensor Wearable Device (MSWD) for source localization of transient pressure events, comprising at least:
one pressure transducer,
one other sensor that measures a parameter of a blast and/or navigational data,
means for sensing and recording data from a pressure source, and
means for processing the sensed data.

4. The MSWD of claim 3, wherein the MSWD can be a Multi-Directional Blast Sensor (MDBS) comprising multiple pressure sensors, inertial sensors, and navigational sensors, all in fixed positions within the device and time synchronization between all sensors.

5. Method(s) of claim 1 for determining a pressure source(s), location(s), and distribution(s) using:
an array of MSWD,
a network connection interconnecting the MSWD, and
a server, computer, or external computation devices that aggregates the data from the networked MSWDs.

6. The MSWD of claim 3, wherein the MSWD can be multiple wearable devices.

7. The MSWD of claim 3, wherein the MSWD incorporates multiple pressure transducers.

8. The MSWD of claim 3, wherein the MSWD incorporates inertial sensors and navigational sensors.

9. The MSWD of claim 3, wherein the MSWD incorporates multiple pressure transducers, inertial sensors, and navigational sensors.

10. The MSWD of claim 3, wherein other sensors beyond pressure, inertial, or navigation sensors can be incorporated into the MSWD to determine additional aspects of the event and the same analytical approaches can be used to determine source signal position for the sensed signal of interest.

11. The MSWD of claim 3, further comprising:
a recording instrument for sampling data,
means for processing the sampled data, and
means for recording the processed data to a non-volatile memory.

12. The Multi-Sensor Wearable Device of claim 3, wherein the sensed data is processed in real-time to calculate the position of the pressure source with respect to the MSWD.

13. The MSWD of claim 3, wherein the sensed data is recorded to a non-volatile memory, and post-processed using an external device selected from the group consisting of a mobile device and/or a computer, the data being transferred wirelessly or via a wired connection.

14. The MSWD of claim 3, where the wearable device(s) is powered with a battery and all sensors are wired to a central controller.

15. The MSWD of claim 3, where the wearable device(s) is externally powered, and sensors are wired to external devices.

16. The MSWD of claim 3, where 2D or 3D analytical methods can be used to determine a source pressure location.

17. The method of claim 1, where the source(s), location(s), and distribution(s) are displayed on a map in real-time on a mobile device, or computer.

18. A method for determining the pressure source(s), location(s), and distribution(s) using the MSWD of claim 3, where data from multiple sensors is post-processed later for forensic analysis of the event or events.

19. The method of claim 1, where the source location(s) and distribution(s) are displayed on a map on a mobile device, or computer.

20. A method for displaying other analytics in real-time using the method of claim 1, such as, but not limited to, displaying the frequency of weapon firing events.

21. The MSWD of claim 3, where an indication of the source pressure location is indicated on the MSWD with lights, graphics, sounds, tactile, or other indication means.

22. The MSWD of claim 3, where an indication of the source pressure location is indicated on an external device with lights, graphics, sounds, tactile, or other indication means where the data is transferred wirelessly or wired.

23. The MSWD of claim 3, further comprising of an inertial sensor to determine the orientation of the wearable sensor array during the event and provide an output with respect to a level plane.

24. The MSWD of claim 3, further comprising of a navigational sensor to determine the heading of the wearable sensor array with respect to true north or another geographical location.

25. The MSWD of claim 3, wherein the multi-sensor array further comprises one or more sensors selected from the group consisting of temperature sensors, humidity sensors, light sensors, and sound sensors, to determine additional aspects of the event.
